(19) United States
(12) Patent Application Publication
(10) Pub. No.: US 2005/0132624 A1
(43) Pub. Date: Jun. 23, 2005

(54) Photovoltaic device for illuminating mailbox address

(76) Inventors: Frank Fang Gao, Neward, DE (US); Richard Renrong Zhang, Hockessin, DE (US)

Correspondence Address: Richard Zhang, 133 Brook Run, Hockessin, DE, 19707, US

(21) Appl. No.: 11/015,567

(22) Filed: Dec. 18, 2004

Related U.S. Application Data
(60) Provisional application No. 60/531,272, filed on Dec. 18, 2003.

(51) Int. Cl. G09F 13/22

(52) U.S. Cl. 40/544

(57) ABSTRACT

A photovoltaic illuminating device, comprising solar cell, electronic circuit, two rechargeable batteries, an illuminating means and a display frame to illuminate during nighttime a house's street address numerals on a roadside mailbox or its supporting post, using solar energy collected and stored in the rechargeable batteries during daytime, is disclosed.

### CROSS-REFERENCE TO RELATED APPLICATIONS

This application claims priority from US Provisional Application Ser. No. 60/531,272, filed on Dec. 22, 2003, and the contents of which is incorporated herein by reference in its entirety.

### BACKGROUND OF THE INVENTION

1. Technical Field of the Invention

Our present invention pertains to a photovoltaic illuminating device for a street address number on a roadside mailbox. In particular, the stand-alone device can be easily installed onto an existing mailbox or its post. It employs one thin-plate solar cell to absorb solar energy during daytime, and one or two light-emitting diodes (LED) to shed light to address numerals during nighttime.

2. Description of Prior Art

In US, Canada and other countries, the address number sign of a residential house is often labeled on the mailbox or its supporting post alongside the street in front of the house. It is a common experience that, in the evening and during nighttime, locating a specific address in a dark or poorly lighted neighborhood is oftentimes a difficult job. Fire departments across America all agree that one of their most difficult tasks in their nighttime emergency operations is to figure out which house the call has come from. Our present invention has been developed to solve this problem.

Our reference search has revealed a few patented solar energy devices and related applications that intended to provide illuminating help for signs and other residential uses. Solar-powered illuminated mailbox address signs are disclosed in U.S. Pat. Nos. 5,460,325 and 5,522,540 to Surman, and U.S. Pat. No. 6,076,294 to Durbin.

U.S. Pat. No. 5,522,540, as a Continuation-In-Part of U.S. Pat. No. 5,460,325, discloses an illuminated mailbox address assembly, and describes the mailbox structure changes required for installing the assembly. In brief, the referenced patent would require a homeowner either to adopt a new mailbox structure (for rural type mailbox) or to reconstruct an existing mailbox (for urban type mailbox) in order to install the illuminated address number assembly. In other word, replacing and restructuring the existing mailbox would be necessary for using the referenced patent.

U.S. Pat. No. 6,076,294 discloses a solar-powered illuminated mailbox address plate which can be attached to one side of a mailbox. The referenced patent uses one light-emitting diode (LED) for each indicium (or digit). Thus, for an address number sign with 4 indicia, four LEDs will be used. If two address plates are needed for both side of the mailbox, 8 LEDs will be needed. The referenced patent uses a solar panel and a rechargeable lead-acid battery to provide power for illuminating.

Therefore, it is desirable to create a stand-alone device that uses a minimum number of LEDs, so that the device (1) allows easy installation on an existing roadside mailbox without any structural change of the mailbox itself, (2) is energy-saving and in a compact form, and (3) is practically and commercially doable and affordable. Our present invention presents such a device that does not require replacement or reconstruction of the existing mailbox. A homeowner can install this device easily at any convenient position on an existing mailbox or its supporting post.

### SUMMARY OF THE INVENTION

Generally, as provided by this invention, a photovoltaic illuminating device consists of a commercially available thin-plate solar cell, a printed circuit board (PCB), one or two rechargeable batteries, a lighting means, and an address display means. The solar cell, the PCB and the rechargeable batteries are assembled closely together within an assembly enclosure, while the lighting means and the address display means can be either separated from or integrated with the assembly enclosure.

The solar cell is placed at the top of the assembly enclosure. The PCB and the rechargeable batteries are below the solar cell and within the enclosure. During daytime, the solar cell collects and converts the solar energy to electrical energy, and charges the rechargeable batteries through the PCB. When the evening comes or the ambient light becomes insufficient to see the address number, the charged batteries discharge the electrical energy to power the lighting means to illuminate the address number. A photo sensor, connected to the PCB and integrated at the edge of the solar cell plate, controls the PCB to charge the batteries during daytime and to discharge the batteries to power the illuminating means during nighttime.

The enclosure is placed at the top of the mailbox or at the top the mailbox post, via adhesive means or mounting screws. Preferably, the enclosure is tilted to allow the solar cell to face the Sun's position around the noontime, thus, colleting the maximum amount of solar energy. For this purpose, the enclosure is installed on the mailbox post via two L-shaped brackets that allow two rotational adjustment of the solar cell orientation.

The lighting means, preferably a light-emitting diode (LED), is connected with the rechargeable batteries via an electrical extension wire, and is connected to an address display means. Preferably, an address display means is a hollow rectangular frame with each face being a diffuser plate (such as a semi-transparent plastic plate). An LED, electrically wired from the enclosure, is located inside one end of the frame and sheds light into the hollow frame. Preferably, another so-wired LED is installed at the opposite end of the frame and sheds light into the hollow frame from an opposite direction. Individual self-adhesive numerals (digits) stick to the outer face of each diffuser plate to form the address number. The rectangular frame is in horizontal or vertical position and is attached to the mailbox or fixed to the side of the post. Preferably, the display frame stays horizontal and is placed on the top of the mailbox. Preferably, further, the afore-mentioned assembly enclosure and the display frame are integrated together to become one solid single unit that is then placed horizontally at the top of the mailbox or attached vertically to the mailbox post.

Preferably, optical fiber panels are used in the hollow space within the display frame and between the two diffuser plates. Light-emitting diodes are used to serve as light sources for the optical fiber panels. Advantage of using optical fiber panels is to provide a uniform lighting background for the address numerals on the diffuser plates.

Besides the intended use of the invention, which is to provide aid for visitors to identify street addresses on mailboxes, the illuminating device immediately adds a pleasant and impressive nighttime landscaping feature to any residential neighborhood.

### BREIF DESCRIPTION OF THE DRAWINGS

FIG. 1 is a perspective view of one embodiment of the present invention of an illuminating device for a street address number on a roadside mailbox.

FIG. 2, in a greater scale as compared to FIG. 1, is an exploded view of an assembly box to house a solar cell, a photo sensor, a printed circuit board (PCB), and two rechargeable batteries.

FIG. 3, in a greater scale as compared to FIG. 1, is a preferred address display frame and one cross-section view of the frame.

FIG. 4, in a greater scale as compared to FIG. 1, is an exploded view of an address display frame using optical fiber panels as lighting background.

FIG. 5 is a perspective view of another embodiment showing a vertical display frame installed on a mailbox post.

FIG. 6, in a greater scale as compared to FIG. 1, is a perspective view of a preferred adjustable bracket to be used to install the assembly enclosure to a mailbox post.

FIG. 7 is perspective view of another embodiment showing an integrated one-unit illuminating device installed on the top of a mailbox.

### DETAILED DESCRIPTION OF THE PREFERRED EMBODIMENT

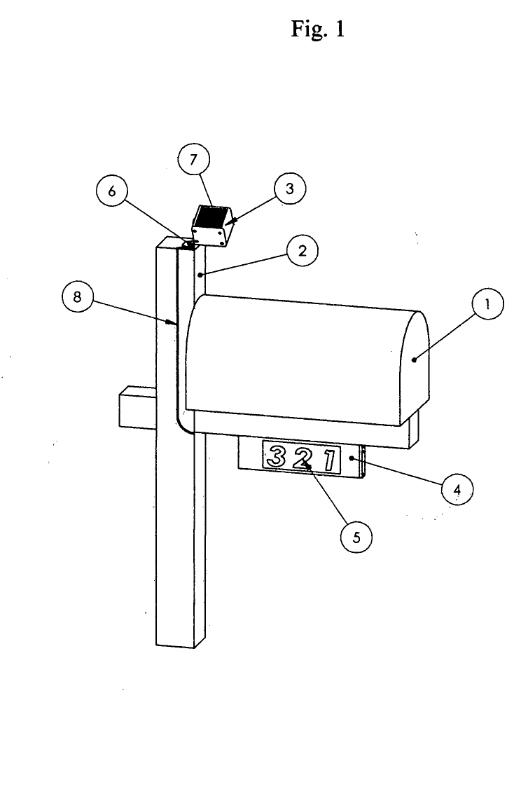

The present invention and its preferred embodiment are described in detail in this section with reference to FIG. 1 through FIG. 7 as listed in the previous section. As shown in FIG. 1, a photovoltaic illuminating device based on the present invention is mounted on an existing mailbox 1 and its post 2. The illuminating device consists of an assembly enclosure 3 and an address display frame 4 with an address number sign 5. The assembly enclosure 3 is installed on the mailbox post 2 via adjustable brackets 6. A commercially available solar cell 7 is at the top of the assembly enclosure to collect solar energy during daytime. An electrical extension wire 8 is used to connect the enclosure 3 to the address display frame 4.

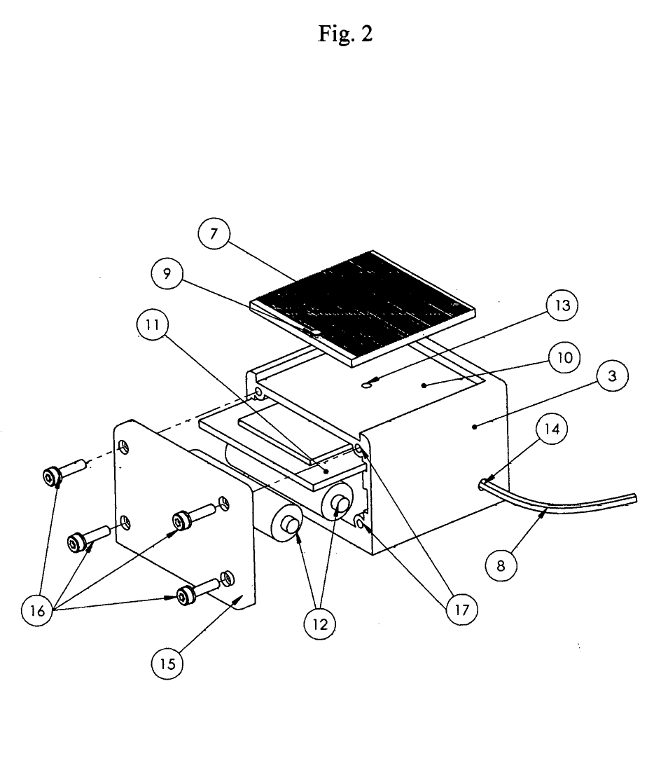

As shown in FIG. 2, a solar cell 7 sits on the top of the assembly enclosure 3. Water-resistant glue is used to attach the solar cell 7 firmly into a sink 10 at the top of the enclosure 3. A photo sensor 9 is imbedded at one edge of the solar cell 7. Alternatively, the photo sensor is installed at one top edge of the enclosure 3 or other suitable locations. A printed circuit board (PCB) 11 and two small rechargeable batteries 12, preferably Size AA batteries, are sitting inside the assembly enclosure 3. A hole 13 at the center of the sink 10 exists to allow wiring among the solar cell 7, the photo sensor 9, and the PCB 11 inside the enclosure 3. An electrical extension wire 8 from the PCB 11 comes out from the enclosure 3 through a small hole 14 to outside the enclosure to the address display frame (not shown in FIG. 2). This wiring hole is sealed with water-resistant glue. A removable endplate 15 is used to close tightly the opening of the enclosure 3 with two screws 16 that go into four matching inserts 17. Preferably, a water-resistant sealing layer (not shown in FIG. 2), made from such material as rubber, exists between the endplate 15 and the opening edge of the enclosure 3 to prevent rainwater and melting snow from entering into the enclosure.

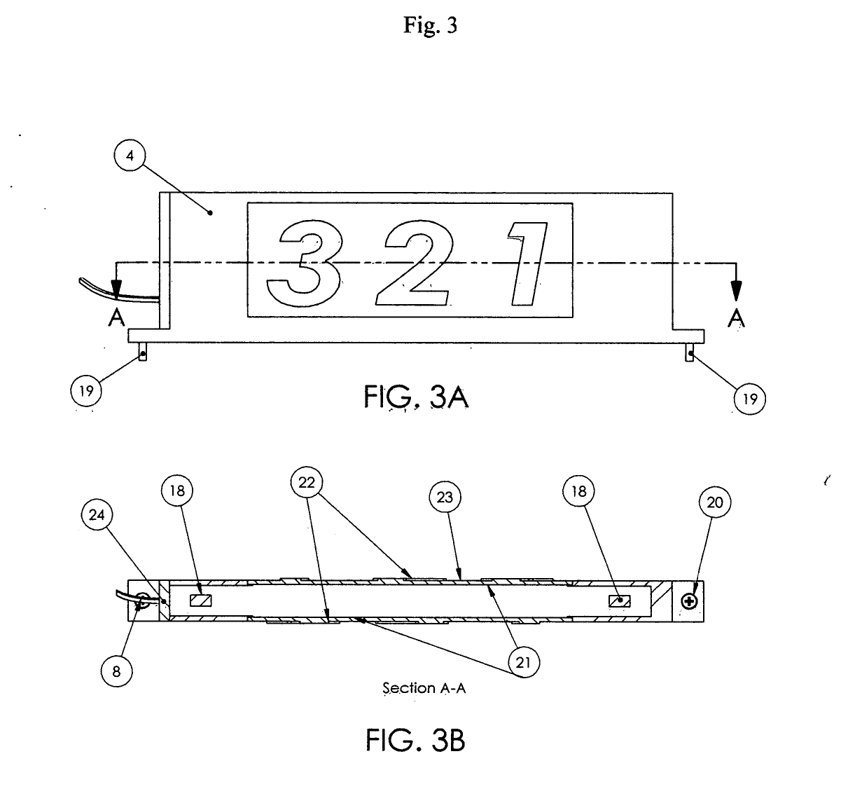

A preferred form of the display frame is shown in FIG. 3, where FIG. 3a is a front view of the display frame 4 with address numbers 22 on both faces (only the front face number is shown in FIG. 3a). Two mounting screws 19 are provided to fasten the frame to the mailbox or its post. FIG. 3b is a cross-section view of A-A section, as indicated in FIG. 3a. As shown in FIG. 3b, the display frame 4 is a hollow frame, with two semi-transparent plastic plates as its two flat diffuser plates 21. Two LEDs 18 sit at two ends of the frame 4 and are connected to the PCB 11 inside the assembly enclosure 3 by electrical extension wire 8 (as shown in FIG. 2). Three Self-adhesive numerals 22 (for the three-digit address sign [321]) adhere onto the outer surface 23 of each flat diffuser plate 21. A removable endplate 24 is provided to seal one open end of the display frame 4.

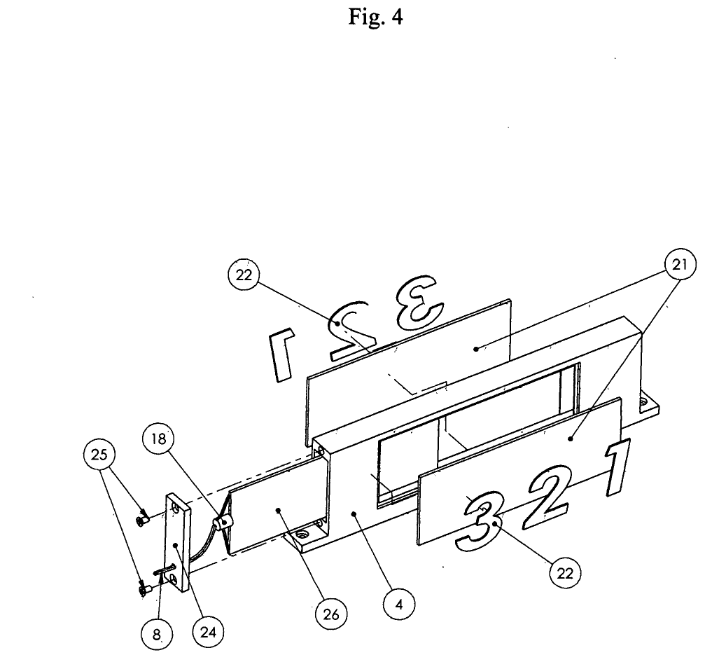

Preferably, optical fiber panels 26, are used in the hollow space of the display frame 4, between two diffuser plates 21, as shown in FIG. 4. Light-emitting diodes 18, as light sources, are used at end of the fiber panels 26. The LEDs are connected to the PCB 14 inside the assembly enclosure 3 by extension wire 8 (as shown in FIG. 2). The said optical fiber panels provide a uniform bright lighting background for the address numerals 22 on the diffuser plates 21. The endplate 24 closes the frame opening tightly with two mounting screws 25.

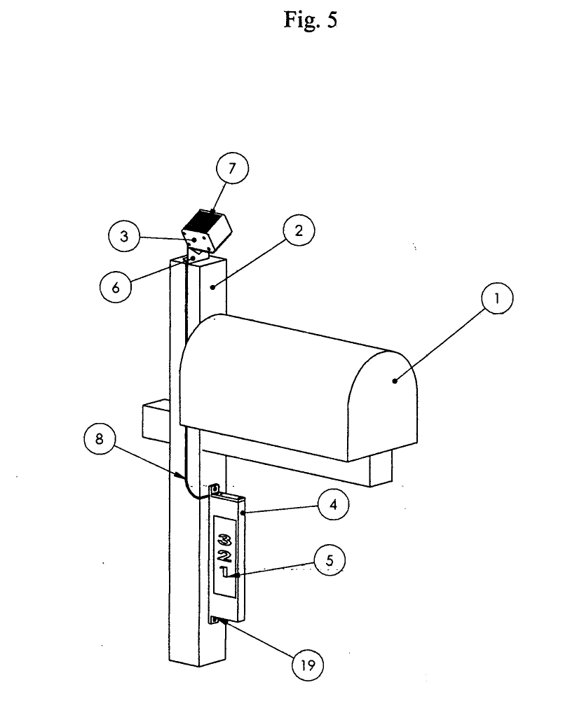

Alternatively, the address display frame 4 takes a vertical position with address numerals 22 being aligned vertically, as showed in FIG. 5. The vertical address frame 4 is then installed on the mailbox post 2 via mounting screws 19, as shown in FIG. 5.

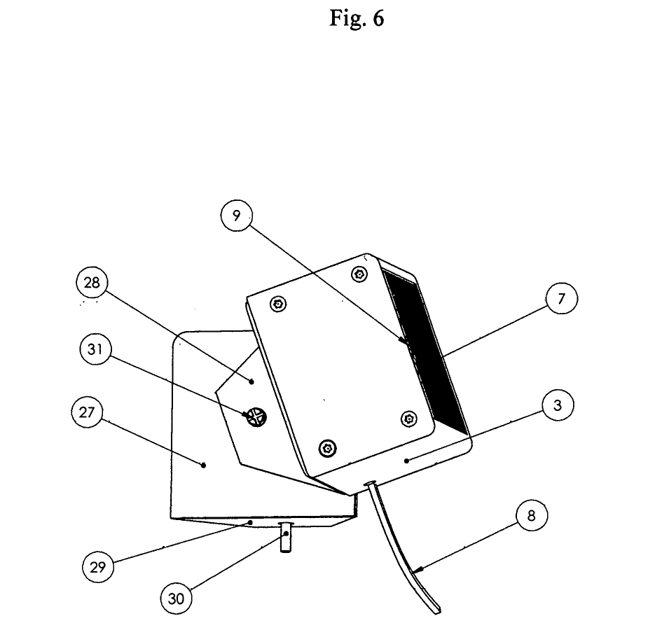

As shown in FIG. 1, an adjustable bracket set 6 is preferred to be used to install the assembly enclosure 3 on the mailbox post 2. Via the bracket set 6, the assembly enclosure 3 is adjusted to a tilted position that allows the solar cell 7 to face the Sun's position around the noontime when the solar radiation is the strangest. FIG. 6 shows a desired design of the said bracket set, which consists of a horizontal arm 27 and a vertical arm 28. One side 29 of the horizontal arm 27 is in contact with the mailbox post and fastened by an adjusting/fastening screw 30. The horizontal arm 27 rotates with the adjusting/fastening screw 30. The vertical arm 28 rotates with another adjusting/fastening screw 31, as shown in FIG. 6. With these two rotating adjustments, the facing orientation of the solar cell 7 can be adjusted toward a desired direction. After adjustment is done, the horizontal arm 27 and the vertical arm 28 can be fastened tightly by the said screws 30 and 31, respectively.

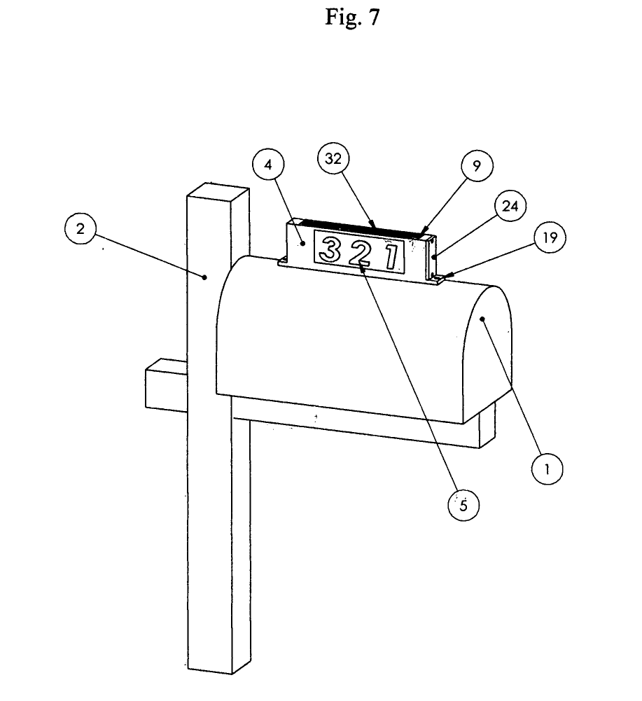

An integrated one-unit device is mounted on the top of an existing mailbox 1 with mounting screws 19, as shown in FIG. 7. The device is a sole display frame 4 with all the afore-mentioned illuminating features, but has extra hollow space to house the rechargeable batteries and the electric circuit (not shown in FIG. 7). It contains the same address number sign 5. A long rectangular solar cell 32 and the photo sensor 9 are at the top of the display frame 4. The open end of the frame 4 is closed tightly with the endplate 24

It is understood that alternative forms and arrangements of this invention, other than those described herein, exist. Such alternative forms and arrangements may be made without departing from the scope and spirit of this invention.

1. In combination, a photovoltaic device for illuminating a street address on a roadside mailbox, said device comprising an assembly box, a solar cell, two rechargeable batteries, a lighting means, an electric circuit, two mounting brackets, a rectangular address display frame.

2. The combination of claim 1, wherein the assembly box is a length-by-width square enclosure, the thickness of said enclosure shaped to house said rechargeable batteries and said electric circuit.

3. The combination of claim 1, wherein the solar cell is a square thin-plate solar cell attached to the top surface of said assembly box as in claim 2, and collects solar energy and converts said solar energy to electric energy during daytime.

4. The combination of claim 1, wherein the rechargeable batteries store said electric energy as in claim 3 during daytime, and discharge said stored energy to power said lighting means during night time.

5. The combination of claim 1, the address display frame is a hollow rectangular frame, said frame having two semi-transparent flat diffusers attached to its two sides, said flat diffusers designed to allow self-adhesive address numerals to stick to said diffusers' outer surface.

6. The combination of claim 1, wherein the lighting means are two light-emitting diodes, one said diode installed at one end of said rectangular display frame as in claim 5, and one said diode installed at the opposite end of said rectangular display frame as in claim 5, said diodes wired to said electric circuit.

7. The said lighting means as in claim 5 further comprising two optical fiber panels, said panels adapted to inside dimension of said address display frame, using said light-emitting diodes as light sources, creating a uniform lighting background for both flat diffusers as in claim 5.

8. The combination of claim 1, wherein the electric circuit charges said batteries using said electric energy as in claim 3 during daytime, and transmits said discharged energy as in claim 4 to power said light-emitting diodes as in claim 6 during nighttime.

9. The said device as in claim 1 further comprising a photo sensor installed besides said solar cell at the top surface of said assembly box as in claim 2, said photo sensor incorporated into said electric circuit as in claim 8, sensing ambient light level to operate said electric circuit for said charging process during daytime and said transmitting process during nighttime as in claim 8.

10. The combination of claim 1, wherein the two mounting brackets are both L-shaped, one said bracket attached to bottom surface of said assembly box, one said bracket attached to surface of mailbox post, permitting two rotational adjustments of said assembly box to position said solar cell to absorb the maximum solar energy during daytime.

11. In combination, a photovoltaic device for illuminating a street address on a roadside mailbox, said device comprising a rectangular address display frame, a solar cell, two rechargeable batteries, a lighting means, an electric circuit.

12. The combination of claim 11, wherein the address display frame is a hollow rectangular frame, said frame having two semi-transparent flat diffusers attached to its two sides, said flat diffusers designed to allow self-adhesive address numerals to stick to said diffusers' outer surface.

13. The said address display frame as in claim 12 further having a hollow space at one end, said space adapted to house said rechargeable batteries and said electric circuit.

14. The combination of claim 11, wherein the solar cell is a long rectangular thin-plate solar cell attached to the top surface of said address display frame as in claim 12, and collects solar energy and converts said solar energy to electric energy during daytime.

15. The combination of claim 11, wherein the rechargeable batteries store said electric energy as in claim 14 during daytime, and discharge said stored energy to power said lighting means during nighttime.

16. The combination of claim 11, wherein the lighting means are two light-emitting diodes, one said diode installed at one end of said rectangular display frame as in claim 12, and one said diode installed at the opposite end of said rectangular display frame as in claim 12, said diodes wired to said electric circuit.

17. The said lighting means as in claim 16 further comprising two optical fiber panels, said panels adapted to inside dimension of said address display frame as in claim 12, using said light-emitting diodes as in claim 16 as light sources, creating a uniform lighting background for both flat diffusers as in claim 12.

18. The combination of claim 11, wherein the electric circuit charges said batteries using said electric energy as in claim 14 during daytime, and transmits said discharged energy as in claim 15 to power said light-emitting diodes as in claim 16 during nighttime.

19. The said device as in claim 11 further comprising a photo sensor located besides said solar cell as in claim 14 at the top surface of said display frame as in claim 12, said photo sensor integrated into said electric circuit as in claim 18, sensing ambient light level to operate said electric circuit as in claim 18 for said charging process during daytime and said transmitting process during nighttime as in claim 18.
